(19) United States
(12) Patent Application Publication
(10) Pub. No.: US 2018/0037330 A1
(43) Pub. Date: Feb. 8, 2018

(54) DETACHABLE FLOATING EQUIPMENT

(71) Applicant: STEVE TORRES, BROOKLYN, NY (US)

(72) Inventor: STEVE TORRES, BROOKLYN, NY (US)

(21) Appl. No.: 15/225,853

(22) Filed: Aug. 2, 2016

(51) Int. Cl. B64D 25/18; B64D 25/20

(52) U.S. Cl. CPC B64D 25/18; B64D 25/20

(57) ABSTRACT

The present invention relates to a detachable floating equipment to deploy on impact with the water and enabling stabilization of the aircraft for the prevention of the aircraft from sinking, until the surviving passengers and crew members is been rescued.

### FIELD OF THE INVENTION

The present invention relates to at least one detachable floating bag to deploy on impact with the water and enable stabilization of the aircraft for the prevention of the aircraft from sinking, until the surviving passengers and crew members is been rescued.

### BACKGROUND OF THE INVENTION

In the recent years, the world has witnessed several horrific airline accidents resulting in hundreds of deaths. When an airplane crashes into the ocean, there is no time for the passengers and crew to escape before the plane sinks, drowning everyone on the plane. When the plane breaks into sections as it strikes the water, the lives of some of the passengers may be spared if the individual sections did not sink quickly.

Moreover, aircrafts technical faults can only be fixed when the aircraft is not in a working position, once the aircrafts take off in order to complete it desirable ride from one place to another it becomes very difficult for any of the engineer to maneuver any default in any machinery involved in the construction of the aircraft.

However, parachutes have been used in connection with aircraft to retard the speed of the aircraft during landing procedures. However, it would be highly desirable to have aircraft safety apparatus which would assist the maneuverability of disabled aircraft and would assist in emergency landing operations. In this regard, it would be desirable where an airplane or other aircraft that loses power due to some technical fault could do secure landing, and remain maneuverable during such emergency landing procedures to avoid disasters, thereby protecting lives and equipment.

Therefore, there remains a need to overcome above mentioned problems and our invention resolve this entire problem.

### SUMMARY OF THE INVENTION

The main objective of the present invention is to overcome the limitations of the prior arts by providing at least one detachable floating bag, to support different sections of the aircraft. In a situation of an aircraft failure, the at least one detachable floating bag is designed to detonate from each side of the aircraft in order to keep the aircraft in the upright position and protect survivors from drowning until they are rescued. The at least one detachable floating bag is self-inflating, like an airbags in other vehicles, so they do not take up valuable space in the airplane. The at least one detachable floating bag is there to provide a new safety feature for an aircraft, in case of an emergency landing of the aircraft over a water body. The self-inflating at least one detachable floating bag stabilizes a crashed aircraft by maintaining its upright position and thus prevents the aircraft from sinking & saving many lives on the aircraft before being rescued and further enable at least one light attachment which enables visual identification of the detachable floating bag and a persons involved in the emergency landing of the aircraft thereby, makes the aircraft easily visible and also, easy to locate. Herein, the aircraft have at least one chamber with an opening, wherein the at least one chamber is located on at least one side of the aircraft. Also, the at least one chamber with an opening is enabled to receive at least one detachable floating bag in flattened state. In a situation, when there is a technical default in the aircraft and the aircraft is enabled to do an emergency landing on a water body then in such situation, as soon as the aircraft comes in contact with water, the water sensors attached to the aircraft get triggered which further enables a reaction that produces nitrogen gas. This nitrogen gas produced is caused by an electrical stimulus, possibly generated by the water sensor which further helps triggering out the at least one detachable floating bag. The at least one detachable floating bag is enabled to come out from an opening of at least one chamber as soon as the water sensor gets the signal of the emergency landing and further comes in contact with water. The at least one detachable floating bag lined up with at least one chemical compound when comes in contact with the water leads to a chemical reaction to produces a buoyant gas (hydrogen) which leads to inflation of at least one detachable floating bag and also enables to keep the aircraft in the upright position for protecting the survivors from drowning until they are been rescued and further enable at least one light attachment which enables visual identification of the detachable floating bag and a persons involved in the emergency landing of the aircraft thereby makes the aircraft easy visible and easy to locate.

Also, in the present invention the aircraft includes a monitor utilizing a network of the sensors, wherein the sensors are coupled to at least one detachable floating bag, wherein the sensors enable sending signal to those onboard the aircraft so as to intimate with the current status of the inflated at least one detachable floating bag. By use of the monitor the observer determines whether at least one detachable floating bag is activated properly and is holding gas properly. In the event that the pressure begins to drop at a level deemed that may no longer support the weight of the aircraft upon the water, then the monitor signals an alarm to indicate the aircraft is losing or has lost enough gas or buoyancy to stay above the water. The at least one detachable floating bag also include an automatic jettisoning of the aircraft data recorder in order to assist in the recovery of valuable aircraft data in the event of the emergency landing.

### BRIEF DESCRIPTION OF THE DRAWINGS

The following drawings illustrates exemplary embodiment; however, they are helpful in illustrating objects, features and advantages of the present invention because the present invention will be more apparent from the following detailed description taken in conjunction with accompanying drawings in which:

FIG. 1 illustrates the perspective view of the detachable floating bag attached with an aircraft according to an embodiment of the invention.

FIG. 2 illustrates the perspective view of the detachable floating bag according to an embodiment of the invention.

### DETAIL DESCRIPTION OF THE INVENTION

Reference will now be made in detail to the exemplary embodiment (s) of the invention, examples of which are illustrated in the accompanying drawings. Whenever possible, the same reference numerals will be used throughout the drawings to refer to the same or like parts.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent computer implemented methods mentioned herein are incorporated herein in their entirety.

The main objective of the present invention is to overcome the limitations of the prior arts by providing at least one detachable floating bag, to support different sections of the aircraft. In a situation of an aircraft failure, the at least one detachable floating bag is designed to detonate from each side of the aircraft in order to keep the aircraft in the upright position and protect survivors from drowning until they are rescued. The at least one detachable floating bag is self-inflating, like an airbags in other vehicles, so they do not take up valuable space in the airplane. The at least one detachable floating bag is there to provide a new safety feature for an aircraft, in case of an emergency landing of the aircraft over a water body. The self-inflating at least one detachable floating bag stabilizes a crashed aircraft by maintaining its upright position and thus, prevents the aircraft from sinking & saving many lives on the aircraft before being rescued and further enable at least one light attachment which enables visual identification of the detachable floating bag and a persons involved in the emergency landing of the aircraft thereby makes the aircraft easily visible and also easy to locate.

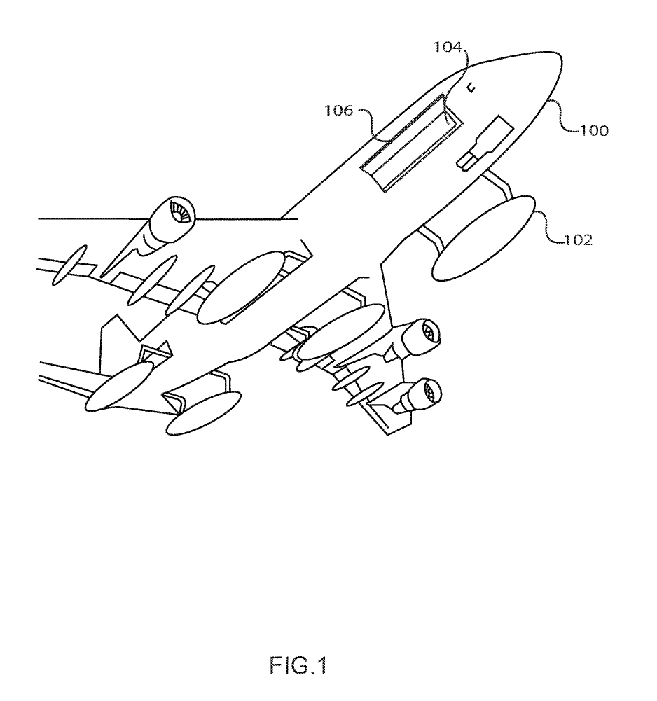

FIG. 1 illustrates the perspective view of the detachable floating bag attached with an aircraft according to an embodiment of the invention. The detachable floating bag [102] attached with an aircraft [100], wherein the aircraft [100] is divided into at least three sections supported by at least one detachable floating bag [102]. The at least three section of the aircraft [100] comprises a crew section, a passenger section and a luggage section, wherein at least one detachable floating bag [102] is coupled to at least three section of the aircraft [100] respectively. The aircraft [100] further have at least one chamber [104] with an opening [106] on at least one side of the aircraft [100] with its location on the front and rear end of the aircraft [100], wherein at least one chamber [104] with an opening [106] is enabled to receive at least one detachable floating bag [102] when in flattened state. In case of any technical default in the aircraft [100], the aircraft [100] is enabled to do emergency landing on any water body then in such situation, as soon as the aircraft [100] comes in contact with water, the water sensors [not shown] attached to the aircraft [100] get triggered which further enables a reaction that produces nitrogen gas. This nitrogen gas produced is caused by an electrical stimulus, possibly generated by the water sensor which further helps triggering out the at least one detachable floating bag [102]. The at least one chamber [104] of the detachable floating bag [102] is then let open and at least one detachable floating bag [102] is let out from an opening [106] provided by at least one chamber [104]. The detachable floating bag [102] herein, also comprises of at least one chemical compound lining which when comes in contact with water the at least one chemical compound (sodium azide) react with water forming at least one gas (hydrogen) wherein at least one gas further enables inflation of at least one detachable floating bag [102]. This inflates at least one detachable floating bag [102] enables to keep the aircraft [100] in the upright position and protect survivors from drowning until they are rescued. This at least one detachable floating bag [102] stabilize the crashed aircraft [100] thereby, preventing the aircraft [100] from sinking and also enables the passengers and the crew members of the aircraft [100] to remain in the upright position that is floating on the surface, so they do not drown before being rescued and further the downed aircraft [100] would be visible, making it easier to locate. This at least one detachable floating bag [102] is enabled to get detached either manually or automatically to provide additional flotation devices or signalling devices in the event that the passengers and the crew must leave the site of the aircraft [100].

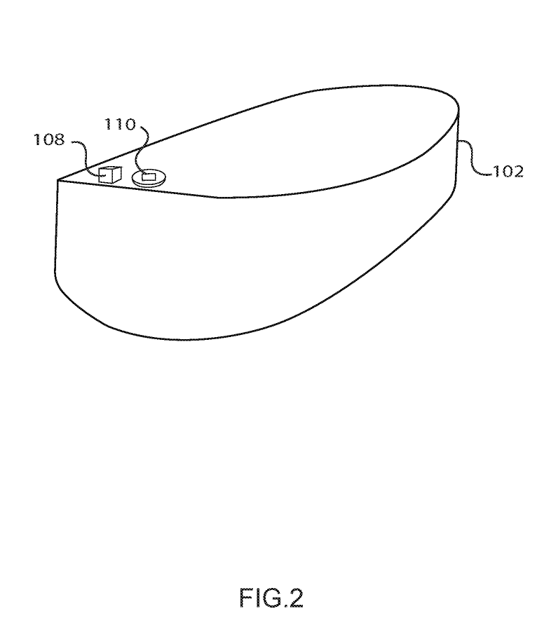

FIG. 2 illustrates the perspective view of the given invention of at least one detachable floating bag [102] according to an embodiment of the invention. The at least one detachable floating bag [102] is enabled to provide aircraft [100] safety, at the time of the emergency landing of the aircraft [100]. This at least one detachable floating bag [102] is further enabled to receive in at least one chamber [104] on at least one side of the aircraft [100] with an opening [106], wherein this opening enables at least one detachable floating bag [102] to come out in order to rescue the aircraft [100] from downing. This at least one detachable floating bag [102] further comprises a layer [not shown], covering the either sides of at least one detachable floating bag [102], wherein the layer is coated with at least one chemical compound enabled to react with water to produce at least one gas wherein at least one gas further enables inflation of at least one detachable floating bag [102]. This at least one detachable floating bag [102] also comprises at least one navigation unit [108] coupled to at least one detachable floating bag [102], wherein at least one navigation unit [108] enables generating GPS signals to communicate the location of at least one detachable floating bag [102] to a remote site. The at least one navigation unit [108] provides at least one light attachment [110] which enables visual identification of at least one detachable floating bag [102] and a persons involved in the emergency landing of the aircraft [100]. The at least one detachable floating bag [102] also include an automatic jettisoning of the aircraft data recorder in order to assist in the recovery of valuable aircraft [100] data in the event of the emergency landing.

In the preferred embodiment of the given invention of at least one detachable floating bag [102]. When there exist a technical default in the aircraft [100] then the aircraft [100] is enabled for an emergency landing on a water body. In a situation, when there is a technical default in the aircraft [100] and the aircraft [100] is enabled to do an emergency landing on a water body then in such situation, as soon as the aircraft [100] comes in contact with water, the water sensors [not shown] attached to the aircraft [100] get triggered which further enables a reaction that produces nitrogen gas. This nitrogen gas produced is caused by an electrical stimulus, possibly generated by the water sensor which further helps triggering out the at least one detachable floating bag In such case the at least one detachable floating bag [102] is enabled to come out from an opening [106] provided in at least one chamber [104]. In such case as soon as at least one detachable floating bag [102] with at least one chemical compound comes in contact with water there exist a chemical reaction in between at least one chemical compound and the water thereby producing a buoyant gas (hydrogen) which enables inflation of at least one detachable floating bag [102]. This inflates at least one detachable floating bag [102] enable to keep the aircraft [100] in the upright position and protect survivors from drowning until they are rescued. This at least one self-inflating detachable floating bag [102] stabilize a crashed aircraft [100] thereby preventing the aircraft [100] from sinking and also enables the passengers and the crew members of the aircraft [100] to remain in the upright position that is floating on the surface, so they do not drown before being rescued and further the downed aircraft [100] would be visible, making it easier to locate.

In another embodiment of the present invention includes a monitor utilizing a network of sensors coupled to at least one detachable floating bag [102], wherein the sensors enable sending signal to those onboard the aircraft [100] so as to intimate with the current status of the inflated at least one detachable floating bag the aircraft [100] also include a monitor utilizing a network of sensors to signal to those onboard the aircraft [100] as to the status of the inflated at least one detachable floating bag [102]. By use of the monitor the observer determines whether at least one detachable floating bag [102] is activated properly and is holding gas properly. In the event that the pressure begins to drop at a level deemed that may no longer support the weight of the aircraft [100] upon the water, then the monitor signals an alarm to indicate the aircraft [100] is losing or has lost enough gas or buoyancy to stay above the water. The at least one detachable floating bag [102] also include an automatic jettisoning of the aircraft [100] data recorder in order to assist in the recovery of valuable aircraft [100] data in the event of the emergency landing.

While the invention has been described in detail with specific reference to preferred embodiments thereof, it is understood that variations and modifications thereof may be made without departing from the true spirit and scope of the invention.

What is claimed is:

1. A detachable floating bag enable to get attach to an aircraft for providing stable and safe emergency landing for the aircraft comprises:
a. a layer, attached on either sides of a detachable floating bag, wherein the covering layer is coated with at least one chemical compound enabled to react with water to produce at least one gas wherein at least one gas further enables inflation of a detachable floating bag; and
b. at least one navigation unit, wherein at least one navigation unit enables generating GPS signals to communicate the location of the detachable floating bag to a remote site.

2. The detachable floating bag in claim 1; wherein at least one navigation unit provides at least one light attachment which enables visual identification of the detachable floating bag and a persons involved in the emergency landing of the aircraft.

3. The detachable floating bag in claim 1; wherein the detachable floating bag is detached either manually or automatically to provide providing stable and safe emergency landing for the aircraft.

4. The detachable floating bag in claim 1; wherein at least one chemical compound is Sodium Azide which is further enabled to react with water to form hydrogen gas providing inflation of the detachable floating bag.

5. The detachable floating bag in claim 1; wherein the detachable floating bag also include an automatic jettisoning of the aircraft data recorder in order to assist in the recovery of valuable aircraft data in the event of the emergency landing.

6. A detachable floating bag enable to get attach to an aircraft for providing stable and safe emergency landing for the aircraft comprises:
a. a layer, attached on either sides of the detachable floating bag, wherein the covering layer is coated with sodium azide enabled to react with water to produce hydrogen gas wherein at least one gas further enables inflation of the detachable floating bag; and
b. at least one navigation unit, coupled to the covering layer of the detachable floating bag, wherein at least one navigation unit enables generating GPS signals to communicate the location of the detachable floating bag to a remote site.

7. The detachable floating bag in claim 6; wherein at least one navigation unit provides at least one light attachment which enables aid in visual identification of a vehicle and a persons involved in the emergency landing of the aircraft.

8. The detachable floating bag in claim 6; wherein the detachable floating bag is detached either manually or automatically to provide an additional flotation device in an event that a passenger and a crew must leave the site of the aircraft.

9. The detachable floating bag in claim 6; wherein the detachable floating bag also include an automatic jettisoning of the aircraft data recorder in order to assist in the recovery of valuable aircraft data in the event of the emergency landing.
